(19) United States
(12) Patent Application Publication
(10) Pub. No.: US 2021/0001654 A1
(43) Pub. Date: Jan. 7, 2021

(54) PRINT HEAD PARAMETER

(71) Applicant: HEWLETT-PACKARD DEVELOPMENT COMPANY, L.P., SPRING, TX (US)

(72) Inventors: Aleix Fort Filgueira, Sant Cugat del Valles (ES); Josep Maria Cuner Utges, Sant Cugat del Valles (ES); Leyre Hernandez Martinez, Sant Cugat del Valles (ES)

(73) Assignee: HEWLETT-PACKARD DEVELOPMENT COMPANY, L.P., SPRING, TX (US)

(21) Appl. No.: 16/977,737

(22) PCT Filed: Apr. 30, 2018
(86) PCT No.: PCT/US2018/030117

§ 371 Date: Sep. 2, 2020

(51) Int. Cl. B41J 29/393

(52) U.S. Cl. CPC B41J 29/393

(57) ABSTRACT

An example method is disclosed of adjusting a print head parameter, the method comprising ejecting a print agent drop from a print head, determining a velocity of the print agent drop, and adjusting the print head parameter based on the velocity of the print agent drop wherein the print head parameter is a number of drops of print agent in an area and/or a density of print agent applied by the print head.

### BACKGROUND

A device such as for example a printing device or additive manufacturing device may include a print head to eject drops of print agent onto a substrate or a layer of build material. Over time, the print head may degrade, or a nozzle of the print head from which print agent is ejected may become partially blocked. This may result in smaller drops being ejected from the print head, and may in some examples also lead to variations in appearance of an image on a substrate.

### BRIEF DESCRIPTION OF DRAWINGS

Examples will now be described, by way of non-limiting example, with reference to the accompanying drawings, in which:

FIG. 1 is a flow chart of an example of a method of adjusting a print head parameter;

FIG. 1 is a flow chart of an example of a method of adjusting a print head parameter;

FIG. 3 shows an example of a graph of a signal output from an example radiation detector;

FIG. 4 is a simplified schematic of an example of apparatus 400 for controlling a print head; and

FIG. 5 is a simplified schematic of an example of a printing device.

### DETAILED DESCRIPTION

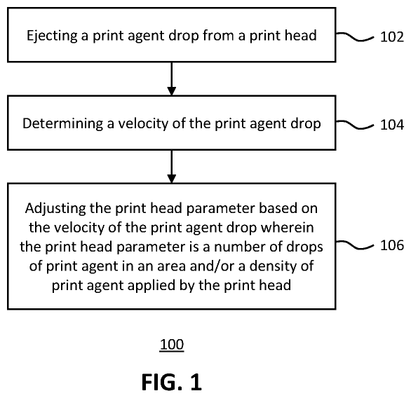

FIG. 1 is a flow chart of an example of a method 100 of adjusting a print head parameter. The method 100 comprises, in block 102, ejecting a print agent drop from a print head. This may comprise, in some examples, sending a signal to the print head to eject the print agent drop, for example from a selected nozzle of the print head. The signal may in some examples be a pulse of a predetermined voltage, current and/or width.

The method also comprises, in block 104, determining a velocity of the print agent drop. This may be done in any suitable manner. In some examples, a radiation source (e.g. a light source) and a radiation detector (e.g. optical detector) may be used, and the print agent drop, once ejected from the print head, moves between the radiation source and the detector and may cast a shadow on the detector. The resulting signal output from the detector may be analysed to determine the velocity of the print agent drop. In some examples, a smaller print agent drop may result in the print agent drop moving at a higher speed in some technologies, or at a lower speed in other technologies. In a further example, an acoustic sensor may be used to determine drop velocity.

The method 100 also comprises, in block 106, adjusting the print head parameter based on the velocity of the print agent drop, wherein the print head parameter is a number of drops of print agent in an area and/or a density of print agent applied by the print head. In some examples, a higher velocity may correlate to a print agent drop of lower size, mass or volume in some technologies, or to a print agent drop of higher size, mass or volume in other technologies. As a result, the number of drops of print agent in an area (e.g. the number of drops per unit area, or drop number density) may be adjusted, for example to compensate for the smaller drop size being ejected from the print head. In some examples, the density of print agent applied by the print head may be adjusted in response to a higher velocity of the print agent drop.

In some examples, the print head parameter may be used to scale the print agent drop number density of print agent applied by the print head to a substrate when forming an image. For example, if print data specifies that a region of the substrate should receive a first drop number density of print agent to form part of the image, the print agent parameter may in response to the velocity scale the first drop number density to a second drop number density. For example, where a faster than expected velocity for the print agent drop is determined, which may indicate a smaller than expected print agent drop, the print agent parameter may scale the first drop number density to a second drop number density, for example to compensate for the smaller print agent drops applied by the print head. The second drop number density may in some examples be adjusted to be higher in some technologies for a higher velocity, or lower in other technologies for a lower velocity.

FIG. 2 is a flow chart of an example of a method 200 of adjusting a print head parameter. The method comprises, in block 204, ejecting the print agent drop from a print head, and in block 206, determining a velocity of the print agent drop. In some examples, the blocks 204 and 206 of the method 200 are similar or identical to the blocks 102 and 104 of the method 100 described above with respect to FIG. 1. In some examples, the method 200 first comprises aligning a nozzle of the print head with a detector to detect the velocity of a print agent drop (e.g. after being ejected from the print head), wherein the print agent drop is ejected from the nozzle.

The method 200 also comprises, in block 208, estimating a drop parameter, e.g., one of a size, weight, mass and volume of the print agent drop based on the velocity. For example, the size, weight, mass or volume may be derived from a predetermined relationship between the velocity and the size, weight, mass or volume, such as for example a linear relationship, a curve, or a relationship that is determined experimentally. In block 210, the method 200 comprises adjusting the print head parameter based on drop parameter, i.e., the velocity of the print agent drop wherein the print head parameter may be a number of drops of print agent in an area and/or a density of print agent applied by the print head. In some examples, block 210 of the method 200 is similar or identical to block 106 of the method 100 described above with respect to FIG. 1. In some examples, adjusting the print head parameter comprises adjusting the print head parameter based on the one of the size, weight, mass and volume. In some examples, adjusting the print head parameter comprises adjusting the print head parameter to compensate for a difference between the estimated one of the size, weight mass and volume of the print agent drop and a predetermined value for the one of the size, weight, mass and volume. For example, the print head parameter may be adjusted such that when forming an image, the print head applies a greater number of drops to an area if the size, weight mass or volume of the print agent drops is smaller than the predetermined value.

In some examples, adjusting the print head parameter based on the velocity comprises determining the print head parameter from the velocity using a lookup table. The lookup table may in some examples be provided by a manufacturer or may be determined experimentally.

In some examples, adjusting the print head parameter based on the velocity of the print agent drop comprises calculating, by a controller, the print head parameter based on the velocity.

The method 200 also comprises, in block 212, aligning an additional nozzle of the print head (e.g. if the drop ejected in block 204 is ejected from a different nozzle) with the detector, in block 214, ejecting an additional print agent drop from the additional nozzle of the print head, in block 216, determining a velocity of the additional print agent drop, and in block 218, adjusting an additional print head parameter based on the velocity of the additional print agent drop. Therefore, in some examples, where the print head includes multiple nozzles, and each nozzle applies the print agent or a different print agent, the velocity of drops ejected from the nozzles can be determined, and an additional print agent parameter may be thereby adjusted. For example, the additional print agent parameter may be adjusted to change the number of drops per unit area applied by the additional nozzle of the print head to compensate for a deviation in speed of the additional drop from an expected speed (which may in some examples indicate a deviation of the size, weight mass or volume of the print agent drop from an expected or initial value).

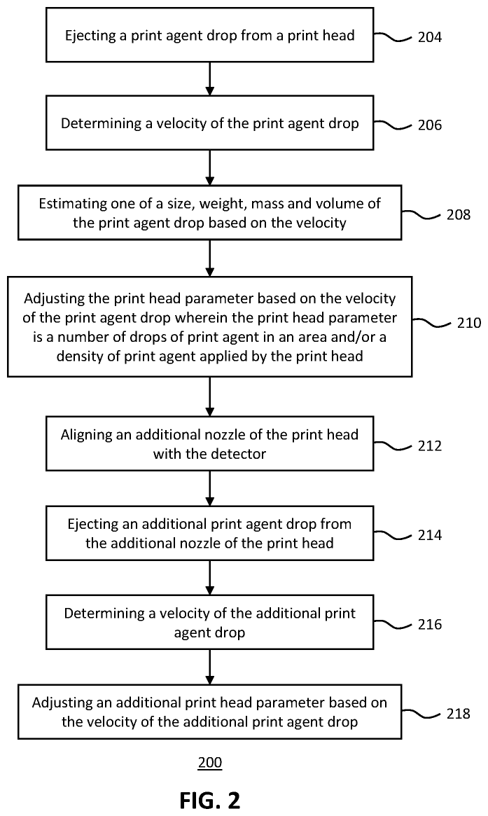

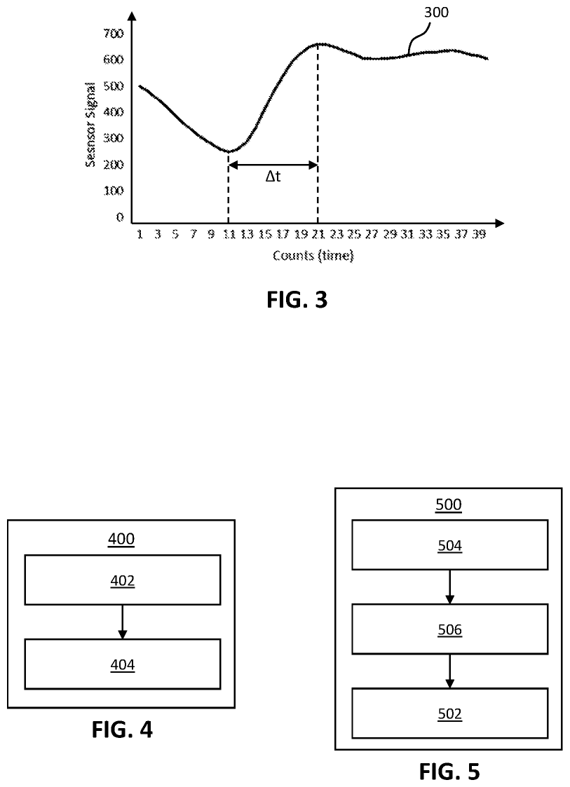

In some examples, determining the velocity of a print agent drop comprises analyzing the output signal of a radiation (e.g. light) detector, whereby the print agent drop is ejected such that it moves between the detector and a radiation (e.g. light) source. FIG. 3 shows an example of a graph of a signal 300 output from an example detector. At around time t=0, the drop first begins to come between the source and the detector. In the example shown, this causes less radiation to strike the detector and hence the output signal reduces in magnitude. At around 11 time counts, the signal reaches its lowest point, and at around 21 counts, the signal returns to approximately the steady state level where no print agent drop is between the source and the detector. The difference between the time at the lowest point and the time where the signal returns to the steady state, shown as Δt in FIG. 3, and the size of the aperture of the detector, may in some examples be used to determine the print agent drop velocity. In another embodiment the sensor to determine drop velocity is an acoustic-based sensor that may determine a drop velocity, e.g., by calculating it in view of a doppler effect.

In some examples, the method 200 comprises adjusting a drop weight (or size, mass or volume) to ejection parameter profile of the print head based on the velocity, and determining the print head parameter from the adjusted profile. The ejection parameter may be for example a voltage applied to the print head to cause the print head to eject a drop of print agent, for example from a selected nozzle. The profile may indicate the weight of a drop ejected for a range of ejection parameters (e.g. voltages) or a plurality of ejection parameters (e.g. voltages). An initial profile, referred to in some example as a reference profile, may be predetermined, e.g. supplied by a manufacturer of a print head or printing device, or measured, e.g. by a printing device containing a print head.

The reference profile may be adjusted to determine an adjusted profile based on the velocity, e.g. based on the drop weight determined from the velocity. In an example, the reference profile may indicate a drop weight of 7 ng at a voltage ejection parameter) of 24.3V (e.g. giving a colorimetric density status T 0.65 @ 30 ng per 600×600 dpi area cell in Self Adhesive material). From the determined velocity of the ejected drop is obtained the current drop weight using this voltage. A drop weight ratio can be used in some examples as or in a print head parameter to compensate for the difference between the current drop weight and the reference drop weight. For example, where the reference drop weight 7 ng, whereas the print head is ejecting larger drops at 7.15 ng, the ratio is 1.02. Therefore, for example, the print head parameter may be adjusted such that, for example, to print 30 ng of print agent in a 600×600 dpi cell, when using the reference drop weight, 4.3 drops (on average) were applied, with the newly determined drop weight, a reduced number of 4.2 drops (on average) may be applied instead. The drop weight ratio may therefore in some examples be used to scale the number of drops applied to an area (e.g. unit area) by the print head.

FIG. 4 is a simplified schematic of an example of apparatus 400 for controlling a print head. The apparatus 400 comprises a velocity measurement device 402 to provide an indication of velocity of a droplet of print agent provided by the print head. For example, the velocity measurement device may include a radiation source and radiation sensor, whereby the droplet is ejected so as to move between the source and the sensor. The apparatus 400 also includes a print head controller 404 to control a number of drops of print agent distributed per unit area by the print head based on the indication of the velocity of the drop of print agent. For example, the print head controller may cause the print head to apply more drops of print agent per unit area if the velocity measurement device indicates that the velocity of the droplet has increased, for example compared to an expected velocity or a previously measured velocity. In some examples, therefore, the print head controller may control the number of drops per unit area to compensate for any decrease in the size of print agent drops distributed by the print head (e.g. a nozzle of the print head, which may in some examples be aligned with the velocity measurement device 402).

In some examples, the print head controller 404 is to estimate a size of the droplet of print agent based on the velocity and to control the number of drops of print agent distributed per unit area by the print head based on the size. For example, a higher velocity of the droplet of print agent may in some technologies correspond to a smaller droplet, or in other technologies to a larger droplet. In some examples, the print head controller 404 is to control number of drops of print agent distributed per unit area based on a difference between the size of the droplet and a predetermined size.

In some examples, the print head controller 404 is to control the number of drops of print agent distributed per unit area based on a plurality of indications of velocity of a plurality of drops of print agent. For example, the average velocity of a plurality of drops of print agent may be used to control the number of drops of print agent distributed per unit area by the print head.

FIG. 5 is a simplified schematic of an example of a printing device 500 comprising a print head 502, measurement apparatus 504 to measure speed of a drop of print agent ejected from the print head 502, and a processor 506 to calibrate the print agent drop number density for images formed by the print head 502 in response to the speed of the drop of print agent. For example, in some technologies, where the speed is lower than expected or lower than a previously determined value, the processor 506 may calibrate the print agent drop number density to be lower, as the lower speed may indicate larger print agent drops are being ejected from the print head when forming images. In some examples, in other technologies, where the speed is lower than expected or lower than a previously determined value, the processor 506 may calibrate the print agent drop number density to be higher, as the lower speed may indicate smaller print agent drops are being ejected from the print head when forming images.

In some examples, the processor 506 is to modify, based on the speed of the drop of print agent, print data for forming an image on print media (e.g. in 2D printing) or for applying print agent to a layer of build material (e.g. in additive manufacture or 3D printing). In some examples, the processor 506 is to align a nozzle of the print head with the measurement apparatus 504 to measure the speed of the drop of print agent ejected from the nozzle of the print head. In some examples, one or more additional nozzles are also each aligned with the measurement apparatus 504 such that the speed of drops ejected from each of the additional nozzles can also be measured. The processor may thus in some examples modify the drop number density of drops applied by each nozzle based on the speed measurements, for example to compensate for any changes in drop speed or drop size, weight, mass or volume.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

What is claimed is:

1. A method of adjusting a print head parameter, the method comprising:
ejecting a print agent drop from a print head;
determining a velocity of the print agent drop; and
adjusting the print head parameter based on the velocity of the print agent drop wherein the print head parameter is a number of drops of print agent in an area and/or a density of print agent applied by the print head.

2. The method of claim 1, comprising:
estimating one of a size, weight, mass and volume of the print agent drop based on the velocity;
wherein adjusting the print head parameter comprises adjusting the print head parameter based on the one of the size, weight, mass and volume.

3. The method of claim 2, wherein adjusting the print head parameter comprises adjusting the print head parameter to compensate for a difference between the estimated one of the size, weight mass and volume of the print agent drop and a predetermined value for the one of the size, weight, mass and volume.

4. The method of claim 1, wherein adjusting the print head parameter based on the velocity comprises determining the print head parameter from the velocity using a lookup table.

5. The method of claim 1, wherein adjusting the print head parameter based on the velocity of the print agent drop comprises calculating, by a controller, the print head parameter based on the velocity.

6. The method of claim 5, further comprising:
aligning an additional nozzle of the print head with the detector;
ejecting an additional print agent drop from the additional nozzle of the print head;
determining a velocity of the additional print agent drop; and
adjusting an additional print head parameter based on the velocity of the additional print agent drop.

7. The method of claim 1, wherein:
ejecting the print agent drop from the print head comprises ejecting the print agent drop between a light source and an optical sensor; and
determining a velocity of the print agent drop comprises determining the velocity from the output of the optical sensor.

8. The method of claim 1, wherein adjusting the print head parameter comprises:
adjusting a drop weight to ejection parameter profile of the print head based on the velocity; and
determining the print head parameter from the adjusted profile.

9. Apparatus for controlling a print head, the apparatus comprising:
a velocity measurement device to provide an indication of velocity of a droplet of print agent provided by the print head; and
a print head controller to control a number of drops of print agent distributed per unit area by the print head based on the indication of the velocity of the drop of print agent.

10. The apparatus of claim 9, wherein the print head controller is to estimate a size of the droplet of print agent based on the velocity and to control the number of drops of print agent distributed per unit area by the print head based on the size.

11. The apparatus of claim 10, wherein the print head controller is to control number of drops of print agent distributed per unit area based on a difference between the size of the droplet and a predetermined size.

12. The apparatus of claim 9, wherein the print head controller is to control the number of drops of print agent distributed per unit area based on a plurality of indications of velocity of a plurality of drops of print agent.

13. A printing device comprising:
a print head;
measurement apparatus to measure speed of a drop of print agent ejected from the print head;
a processor to calibrate the print agent drop number density for images formed by the print head in response to the speed of the drop of print agent.

14. The printing device of claim 13, wherein the processor is to modify, based on the speed of the drop of print agent, print data for forming an image on print media or for applying print agent to a layer of build material.

15. The printing device of claim 13, wherein the processor is to align a nozzle of the print head with the measurement apparatus to measure the speed of the drop of print agent ejected from the nozzle of the print head.
